(19) United States
(12) Patent Application Publication
(10) Pub. No.: US 2014/0109223 A1
(43) Pub. Date: Apr. 17, 2014

(54) PROVIDING A REAL-TIME ANOMALOUS EVENT DETECTION AND NOTIFICATION SERVICE IN A WIRELESS NETWORK

(71) Applicant: AT&T INTELLECTUAL PROPERTY I, L.P., Atlanta, GA (US)

(72) Inventors: YU JIN, Madison, NJ (US); Cynthia Cama, Belmar, NJ (US); Ann E. Skudlark, Westfield, NJ (US); Lien K. Tran, Chatham, NJ (US)

(73) Assignee: AT&T Intellectual Property I, L.P., Atlanta, GA (US)

(21) Appl. No.: 13/654,320

(22) Filed: Oct. 17, 2012

(51) Int. Cl. H04W 12/00; H04W 68/00

(52) U.S. Cl. 726/23

(57) ABSTRACT

A method and apparatus for providing a notification service in a wireless network are disclosed. For example, the method registers a mobile device associated with a customer for the notification service, collects traffic data related to the mobile device of the customer, determines if an anomaly is detected for the traffic data that is collected for the mobile device, and provides a notification to the mobile device of the customer, if the anomaly is detected for the traffic data that is collected for the mobile device.

The present disclosure relates generally to communication networks and, more particularly, to a method and apparatus for providing a real-time anomalous event detection and notification service in a wireless network, e.g., in a 3G network or in an LTE (long term evolution) wireless network.

### BACKGROUND

As Internet usage continues to grow, more and more customers are accessing communications services via a mobile device, e.g., a cell phone, a smart phone, a computer tablet, etc. However, mobile devices are designed with limited memory and battery capacity. As such, installing antivirus software or a firewall on mobile devices may require too much overhead. As such, mobile device activities are not monitored in real-time for anomalous event detection.

### SUMMARY OF THE DISCLOSURE

In one embodiment, the present disclosure teaches a method and apparatus for providing a notification service in a wireless network. For example, the method registers a mobile device associated with a customer for the notification service, collects traffic data related to the mobile device of the customer, determines if an anomaly is detected for the traffic data that is collected for the mobile device, and provides a notification to the mobile device of the customer, if the anomaly is detected for the traffic data that is collected for the mobile device.

### BRIEF DESCRIPTION OF THE DRAWINGS

The teaching of the present disclosure can be readily understood by considering the following detailed description in conjunction with the accompanying drawings, in which:

FIG. 1 is a block diagram depicting an illustrative network related to the current disclosure;

FIG. 2 illustrates an exemplary network in accordance with one embodiment of the current disclosure for providing a real-time anomalous event detection and notification service;

FIG. 3 illustrates a flowchart of a method for providing a real-time anomalous event detection and notification service;

FIG. 4 illustrates a flowchart of a method for obtaining a real-time anomalous event detection and notification service; and

FIG. 5 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly teaches a method and apparatus for providing a real-time anomalous event detection and notification service, e.g., in an LTE wireless network and the like. Namely, the teachings of the present disclosure can be applied for other wireless networks or cellular networks (e.g., 2G network, 3G networks, 4G networks and the like), wherein anomalous event detection is beneficial to customers of the wireless networks.

Broadly defined, 3GPP is a global effort to define a wireless communication system specification. 2G is a second generation cellular network technology, 3G is a third generation cellular network technology, and 4G is a fourth generation cellular network technology. A Global System for Mobile (GSM) communications is an example of a 2G cellular technology and a Universal Mobile Telecommunications System (UMTS) is an example of a 3G cellular network technology. In accordance with the 3GPP global effort, a General Packet Radio Service (GPRS) refers to a communications service used to transfer data via a cellular network. GPRS is available to users of a 2G cellular system GSM. The GPRS provides an enhancement to the GSM system so that data packets are supported. In addition, in 3GPP release 8, an LTE standard is provided as a set of enhancements to the UMTS. The enhancement focuses on adopting 4th Generation (4G) mobile communications technology to include an all Internet Protocol (IP) end-to-end networking architecture. An LTE is an example of a 4G cellular network technology.

A base station for a 2G network is also referred to as a base transceiver station (BTS). A base station in a 3G network is also referred to as a Node B. For the 4G network, a radio base transceiver station (RBS), as per the 3GPP standards, is referred to as an eNodeB (or simply as a base station). An eNodeB provides an LTE—air interface and performs radio resource management for wireless access.

In one embodiment, a Serving GPRS Support Node (SGSN) refers to a network node responsible for communicating with user endpoint devices and routing of data calls. For example, the SGSN may send and receive data packets to and from user endpoint devices in the coverage area of the SGSN.

In one embodiment, a Gateway GPRS Support Node (GGSN) refers to a network node responsible for the interworking between the GPRS network and external packet switched networks, e.g., the Internet. The GGSN converts the GPRS packets coming from the SGSN into the packet data protocol (PDP) format of the external packet network. For example, the GPRS packet may be converted to an Internet protocol packet prior to being sent to the external network, which is Internet protocol based.

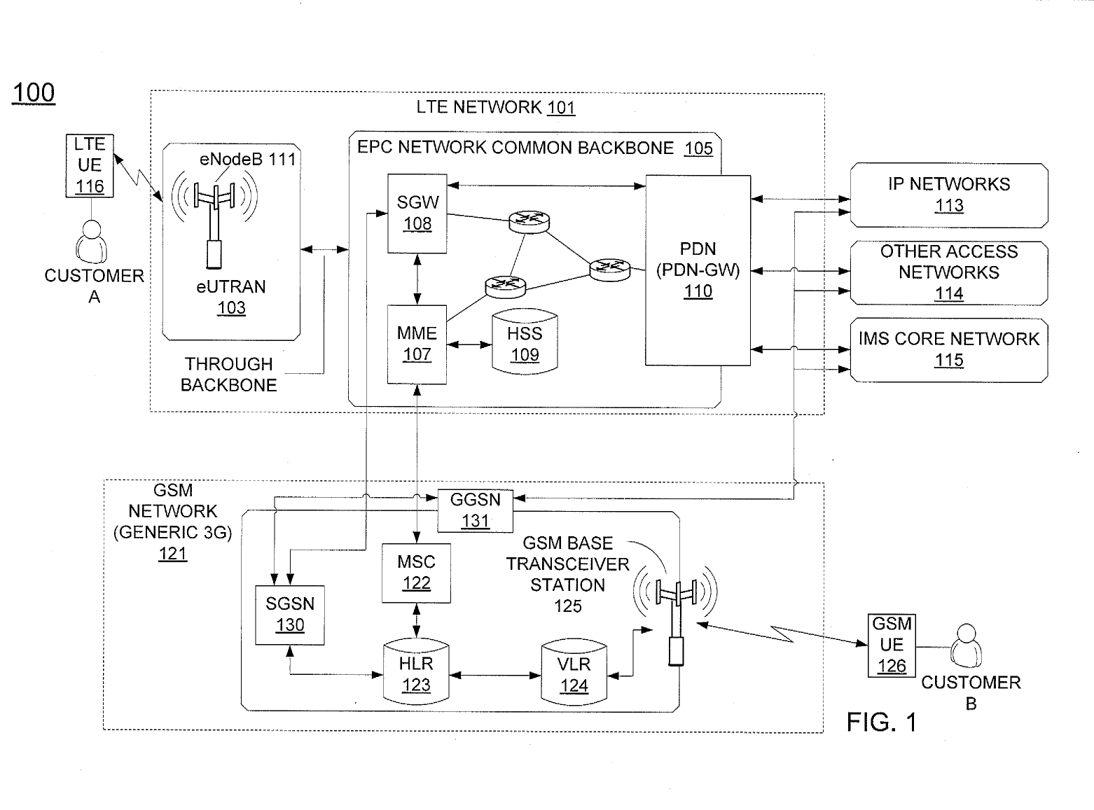

FIG. 1 illustrates an exemplary network 100 related to the present disclosure. In one illustrative embodiment, the network 100 comprises an LTE network 101, a GSM network 121, an IP network 113, other access networks 114, an IP Multimedia Subsystem (IMS) core network 115, LTE user endpoint device 116, and a GSM user endpoint device 126.

The user endpoint devices 116 and 126 can be a smart phone, a cellular phone, a computer or laptop, a computing tablet, or any endpoint communication devices equipped with wireless capabilities.

In one embodiment, the LTE network 101 comprises access networks 103 and a core network 105. In one example, the access network 103 comprises an evolved Universal Terrestrial Radio Access Network (eUTRAN). In one example, the core network 105 comprises an Evolved Packet Core (EPC) network.

The eUTRANs are the air interfaces of the 3GPP's LTE specifications for mobile networks. Namely, the eUTRAN comprises a radio access network standard that will replace previous generations of air interface standards. All eNodeBs in the eUTRAN 103 are in communication with the EPC network 105. In operation, LTE user equipment or user endpoints (UE) 116 may access wireless services via the eNodeB 111 located in the eUTRAN 103. It should be noted that any number of eNodeBs can be deployed in an eUTRAN. In one illustrative example, the eUTRAN 103 may comprise one or more eNodeBs.

An EPC network provides various functions that support wireless services in the LTE environment. In one embodiment, an EPC network is an Internet Protocol (IP) packet core network that supports both real-time and non-real-time service delivery across a LTE network, e.g., as specified by the 3GPP standards.

In EPC network 105, network devices Mobility Management Entity (MME) 107 and Serving Gateway (SGW) 108 support various functions as part of the LTE network 100. For example, MME 107 is the control node for the LTE access-network. In one embodiment, it is responsible for UE (User Equipment) tracking and paging (e.g., such as retransmissions), bearer activation and deactivation process, selection of the SGW, and authentication of a user. In one embodiment, SGW 108 routes and forwards user data packets, while also acting as the mobility anchor for the user plane during inter-eNodeB handovers and as the anchor for mobility between LTE and other wireless technologies, such as 2G and 3G wireless networks.

In addition, EPC (common backbone) network 105 may comprise a Home Subscriber Server (HSS) 109 that contains subscription-related information (e.g., subscriber profiles), performs authentication and authorization of a wireless service user, and provides information about the subscriber's location. The EPC network 105 may also comprise a Public Data Network (PDN) gateway (GW) 110 which serves as a gateway that provides access between the EPC network 105 and various data networks, e.g., other IP networks 113, an IMS core network 115, other access networks 114 and the like. In one embodiment, the EPC network 105 may also comprise a Policy Charging and Rule Function (PCRF) that supports accesses to subscriber databases and specialized functions of a charging system. The Policy Charging and Rule Function (PCRF) can be implemented as a standalone module or implemented as a part of one of the other network modules of the EPC network 105. It should be noted that the EPC network 105 as shown in FIG. 1 is only illustrative and is not limited to the network elements as described above, i.e., there could be additional network elements that are deployed but not discussed.

In one embodiment, the GSM network 121 comprises a mobile switching center (MSC) 122, a home location register (HLR) 123, a visitor location register (VLR) 124, a GSM network base transceiver station 125, a Serving GPRS Support Node (SGSN) 130, and a Gateway GPRS Support Node (GGSN) 131. The GSM user endpoint device 126 accesses a wireless service via the GSM base transceiver station 125, which is located in GSM network 121.

In one embodiment, the interaction may actually be between a user and a network service, e.g., a website. For example, endpoint device 126 may instead by a service provider server, e.g., a streaming service server, and so on. Thus, device 126 does not necessarily represent a device of another customer.

In one embodiment, an MSC refers to a network node that is responsible for communicating with user endpoint devices, routing voice calls and providing other services. For example, the MSC may setup and release end-to-end connections and perform handover during a call to handle mobility of user endpoint devices. In one embodiment, a gateway mobile switching center ((GMSC), not shown) refers to a network node that determines which mobile switching center is currently being visited by a called party. Network services that a user subscribes to are maintained in a subscriber profile. In a 2G network, the subscriber profile is referenced by a home location register.

It should be noted that although various networks are shown as separate networks in FIG. 1, it is possible that functions performed by these networks can be combined into fewer networks or expanded into a greater number of networks depending on the deployment requirements.

It should also be noted that the above illustrated network 100 is only illustrative and the number of network components or elements are not specifically limited as shown. Any number of network components or elements can be deployed.

As the use of wireless technology grows, more and more customers are accessing communications services via a mobile device. However, the mobile devices are designed with limited memory and battery capacity. Migrating anti-virus software and firewall onto a mobile device requires dedicating a significant percentage of the device's memory and battery capacity for security related activities.

In one embodiment, a network service provider may wish to provide a real-time anomaly detection and notification service to customers. The customers may then be able to subscribe to a network based real-time anomaly detection and notification service. For example, a customer may subscribe to a real-time anomaly detection and notification service and register one or more mobile devices.

In one embodiment, the anomaly detection may be based on monitoring of any undesirable behavior or content. For example, the anomaly that is detected for a mobile device may be: the mobile device being infected with a malware, the mobile device being a part of a Botnet, the mobile device engaging in a fraud activity, the mobile device sending and/or receiving a spam message via a Short Message Service (SMS), the mobile device accessing or attempting to access a restricted content, etc. It should be noted that the list of anomalies that may be detected are not limited to the above list. The service provider determines the type of behavior, activity and/or content that constitutes an anomaly and should be detected via the method of the present disclosure.

In one embodiment, for data traffic, the real-time anomaly detection is performed in a core packet network. The method of the present disclosure employs a variety of anomaly signature sources to ensure the accuracy of the detection. In one example, Botnet signatures may be gathered by reverse engineering of bots captured via a honeypot or an external data source. In another example, blacklists may be gathered from other external sources, e.g., GOOGLE safe browsing and domain name servers (DNSs). In one embodiment, the accuracy of the detection may be used to rank an order of the results of the detection and/or an order of implementing remedies to address various anomalies.

In one embodiment, the rules for the detection may be customizable to meet a different security requirement a specified by each customer. In one example, a business customer may want to enforce company specific policy to restrict accessing of websites and phone numbers. In another example, a customer may wish to restrict access to websites containing objectionable content.

In one embodiment, the service provider may have rules for the detection of anomaly for traffic traversing the service provider's network. For example, the service provider may detect that the traffic of a particular customer is being directed to adult websites via its network, when the customer has previously specified that access to websites containing objectionable content should be restricted. This is only one illustrative example.

In one embodiment, the network service provider updates rules for the detection and/or upgrades a detection engine without affecting the customer endpoint devices (e.g., the mobile devices).

In one embodiment, the method of the present disclosure may be implemented via a detection engine. For example, the service provider may implement a real-time anomaly detection and notification engine in an application server. The method may maintain a list of signatures for anomalies for data traffic, a list of voice fraud numbers originating fraudulent voice messages and a list of SMS spam message sources. The method updates the lists in accordance with criteria established by the network service provider. In one example, the criteria may be performing updates in a pre-determined time interval. In another example, the criteria may be based on a number of anomalies that are detected, on the types of anomalies needing updates, on the severity of anomalies that are identified, etc. It should be noted that “real-time” anomaly detection relates to a service that is able to monitor the network traffic as the network traffic is traversing the network infrastructure. In other words, the detection is not implemented to monitor stored network traffic data. Thus, “real-time” anomaly detection is not instantaneous, but relates to a detection process that is operating on the current network traffic that is traversing through the network infrastructure.

The signatures for the anomalies can be learned over time. For example, the signature may be a series of correlated actions (e.g., traversing certain websites in a particular sequence, sending certain messages, and so on) that have been identified to be related to an anomaly. For example, a customer endpoint device that visits a website for a financial institution and then sends a message containing an account number to a known black listed IP address may be indicative of an anomaly, e.g., a malware has been loaded on the endpoint device and is stealing financial information. Another signature may be a sequence of visiting different websites, e.g., visiting a news site and then visiting an adult website, which may indicate that a malware has been loaded on the endpoint device and is redirecting the user's request to another unintended website. These are only illustrative examples of signatures. Other signatures are within the scope of the present disclosure.

The method then collects mobile data traffic, e.g., broadly selectively buffering some or all of the mobile data traffic into a storage device for analysis for a particular time period. For example, the method may collect some of the mobile data traffic via GGSNs and PDN-GWs as discussed above. For example, flow records for network data traffic may be gathered or sampled for a particular time period, e.g., every 5 minute interval, at the beginning of every hour, for the first one minute of every session, for a fixed of amount of traffic data (e.g., “x” megabyte of data) at the beginning or at the end of a session, and the like. The method then analyzes the mobile data traffic that is collected in order to perform the real-time anomaly detection. For example, the detection engine may match the mobile data traffic that is collected against the list of signatures of anomalies for mobile data traffic. For example, the method may compare the mobile data traffic against a list of suspicious domain names, a list of suspicious IP addresses, a list of malwares (e.g., a list of known malwares and/or behavioral patterns that are similar to a malware), etc.

The method also collects voice and SMS traffic. For example, the method may collect the voice and SMS traffic via mobile switching centers (MSCs) and SGWs. The method then analyzes the voice and SMS traffic that is collected in order to perform the real-time anomaly detection. For example, the detection engine may match the originating phone numbers or the terminating phone numbers of the voice and SMS traffic against the list of voice fraud numbers originating fraudulent voice messages and the list of SMS spam message sources.

In one embodiment, if an anomaly is detected, the network service provider notifies the customer whose device is registered and is affected by the anomaly, in accordance with the rules for detection associated with the particular customer. For example, a first customer may have registered one or more devices and indicated a preference to receive notification for each anomaly that is detected. However, a second customer may have registered one or more devices and indicated a preference to receive notification for anomalies that are detected and are of a specific type and/or severity level. In other words, some customers may not be concerned with each and every type of anomalies. The network service provider may then send the notification to each subscriber in accordance with the respective subscriber's preference. In one embodiment, the notification may also be sent to one or more network administrators.

In one embodiment, the notification comprises one or more of: an SMS message that may be sent to a customer endpoint device, a message sent via a push notification service, CTD (Click-To-Dial) messaging, a message indicating a website where the customer may access a customized report of the detected anomaly, and so on. For example, if the customer has a feature phone, the customer may not be able to receive a customized report via the feature phone. However, the customer may be provided with a customized report at a website that may be accessed by a subscriber of the service for real-time anomaly detection and notification. Thus, the customer may be able to receive the notification via a light weight application in the mobile device or on an online report via any device. In one embodiment, the customer is authenticated when accessing the service for real-time anomaly detection and notification. For example, the customer may be required to provide a password or any other standard authentication information prior to gaining access to the online report.

In one embodiment, the service for real-time anomaly detection and notification is provided as a feature of another service. For example, the customer may add the real-time anomaly detection and notification as an additional feature of a wireless service, e.g., a cellular network service.

In one embodiment, the real-time anomaly detection and notification service may be provided as an opt-in service. For example, the customer may opt to receive notification, if the service provider detects any anomalous activity involving his/her endpoint device. In one embodiment, the real-time anomaly detection and notification service may be provided as an opt-out service. For example, the service provider may provide the service such that anomalous activities over the service provider's network can be detected and ultimately reduced. Thus, increasing the number of endpoint devices receiving notification of anomalous activity may be beneficial to the service provider. The service provider may then provide the real-time anomaly detection and notification to a customer, unless the customer specifically opts-out of the service.

In one embodiment, the service for real-time anomaly detection and notification may be a service that is provided at a cost to a customer. In another embodiment, the service may be provided for free to a customer.

In one embodiment, the real-time anomaly notification comprises one or more of: a description of the anomaly that is detected, one or more suggestions for remediation, a level of urgency, descriptions for one or more events that may occur, if a remediation is not pursued, a confidence level for the detection of the anomaly, and so on.

For example, if a service provider determines that the customer endpoint device is receiving and/or sending SMS spam messages, the customer may be provided the following information:
1) a notification that the endpoint device is sending SMS spam messages,
2) a guide to assist in the cleaning-up of the endpoint device;
3) a description of at least a risk associated with not cleaning-up the endpoint device (e.g., cost of sending the SMS messages);
4) x % confident that the detection is not a false positive;
5) a location of a software application for cleaning-up the endpoint device;
6) a guide on restoring one or more settings of the endpoint device from a backup; and/or
7) a location where the customer may receive help to clean-up device.

In one embodiment, the suggestion for remediation may enable the customer to download a script that may be loaded on to the customer's endpoint device in order to clean-up the device. In one embodiment, the service provider may enable the customer to perform the remedy by accessing a URL (universal resource locator) and downloading a software application that performs the remediation.

In one embodiment, the remediation may depend on a type of the customer endpoint device. For example, the remediation for a first type of customer endpoint device may involve the downloading of a software application to the endpoint device and running the software application, while the remediation for a second type of customer endpoint device may involve restoring the setting of the customer endpoint device from a last backup of the setting of the customer endpoint device.

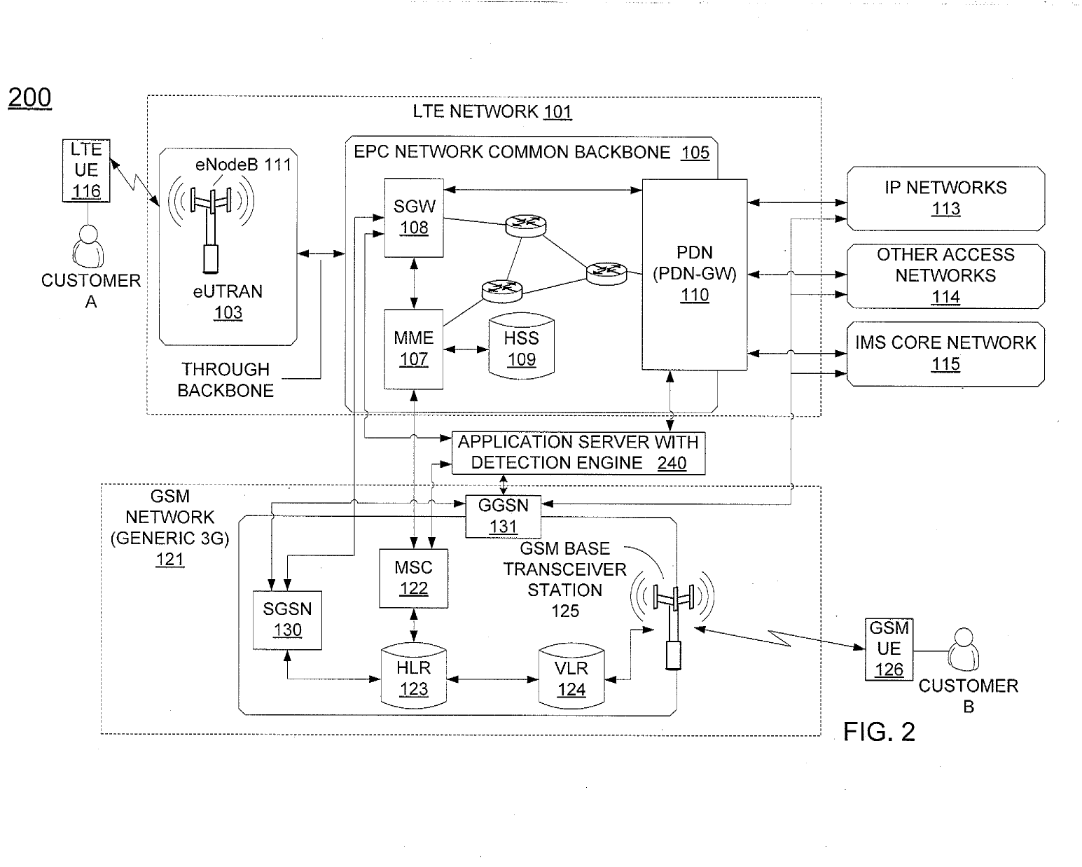

FIG. 2 illustrates an exemplary network 200 in accordance with one embodiment of the current disclosure for providing a real-time anomalous event detection and notification service. The service provider implements the method for real-time anomalous event detection and notification in an application server 240. For example, the application server 240 comprises a detection engine. The application server may maintain a list of signatures for anomalies for data traffic, a list of voice fraud numbers originating fraudulent voice messages, and a list of SMS spam message sources. The application server updates the lists in accordance with criteria established by the network service provider. The customers may then be able to subscribe to a network based real-time anomaly detection and notification service. For example, a customer may subscribe to a real-time anomaly detection and notification service and register one or more of the customers' mobile devices.

In one embodiment, the method collects mobile data traffic, voice traffic and/or SMS traffic for a customer. For example, the application server communicates with MSC 122, GGSN 131, SGW 108 and PDN-GW 110 to gather the flow records for mobile data traffic, and origination records for data, voice and SMS traffic.

The application server then analyzes the mobile data traffic, voice traffic and/or SMS traffic that are collected. For example, the detection engine may match the mobile data traffic that is collected against the list of signatures of anomalies for mobile data traffic. In one example, the method may compare the mobile data traffic against a list of suspicious domain names, a list of suspicious IP addresses, a list of malwares (e.g., a list of known malwares and/or behavioral patterns that are similar to a malware), etc. In another example, the method may match the originating phone number of the voice traffic against the list of voice fraud numbers originating fraudulent voice messages, or the originating phone number of the SMS traffic against the list of SMS spam message sources.

The method then determines if an anomaly is detected for mobile data traffic, voice traffic or SMS traffic. If an anomaly is detected, the application server may notify the customer. For example, the application server notifies the customer in accordance with a rule for anomaly detection and notification associated with the particular customer. In one example, the customer may have registered the customer's mobile device and indicated a preference to receive a notification for each anomaly that is detected. In another example, the customer may have registered the customer's mobile device and indicated a preference to receive notifications for anomalies that are detected and are of a specific type and/or severity level. The notification may then be accessed or received by the customer. In one embodiment, the customer is first authenticated prior to being allowed to access the notification. It should be noted that the application server 240 can be deployed within any one of the above described networks or FIGS. 1 and 2, e.g., the EPC network 105, the GSM network 121 or the IMS core network 115.

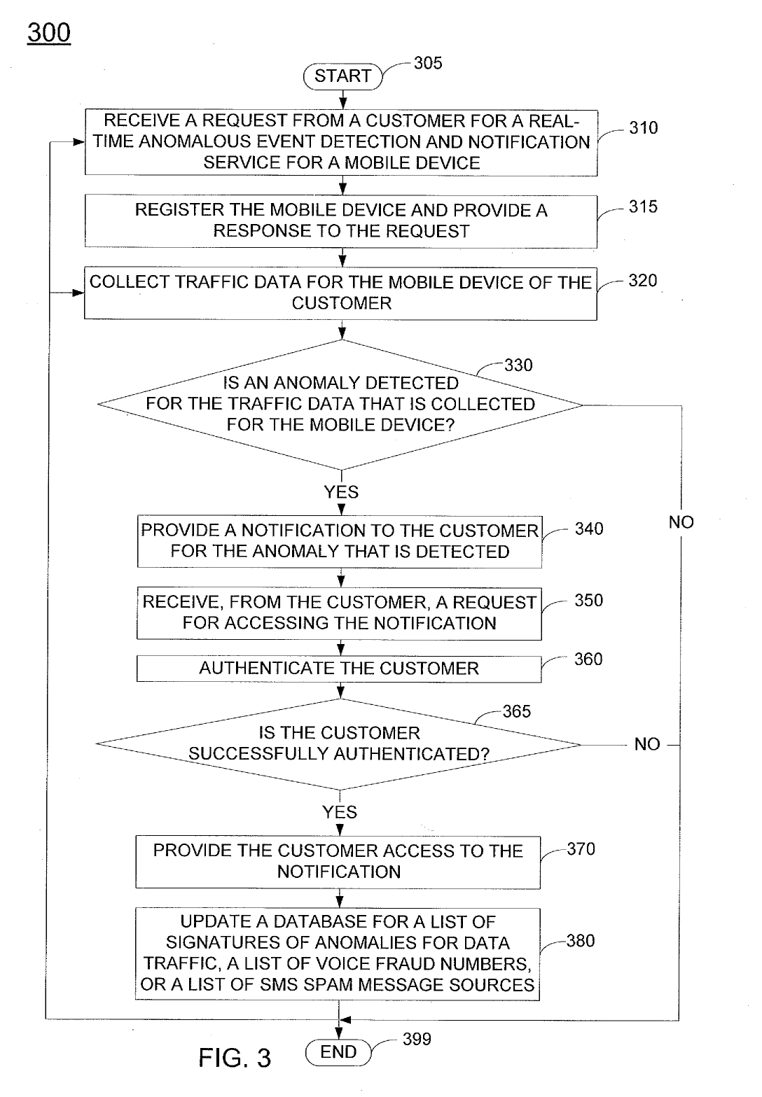

FIG. 3 illustrates a flowchart of a method 300 for providing a real-time anomalous event detection and notification service. In one embodiment, method 300 may be implemented in an application server of a network service provider. Method 300 starts in step 305 and proceeds to step 310.

In step 310, method 300 receives a request from a customer for a real-time anomalous event detection and notification service for a mobile device. For example, a customer may request for a subscription to a real-time anomalous event detection and notification service.

In step 315, method 300 registers one or more mobile devices of the customer and provides a response to the request. For example, the service provider registers the subscription information, customer preferences for anomaly detection and notification, authentication information that may be used for accessing a notification, etc. The service provider then provides a response to the request. The response may comprise confirmation of registration information, preferences, password, etc.

In step 320, method 300 collects traffic data for the mobile device of the customer. For example, the method collects mobile data traffic, mobile voice traffic and/or SMS traffic for the mobile device of the customer. For example, for a mobile device associated with a GSM network, the application server communicates with MSCs and GGSNs to collect the traffic data. For a mobile device associated with an LTE network, the application server communicates with SGWs and PDN-GWs to gather the traffic data.

In step 330, method 300 determines if an anomaly is detected for the traffic data that is collected for the mobile device. In one example, the application server may match the mobile data traffic that is collected against the list of signatures of anomalies for mobile data traffic. In another example, the method may match the originating phone number of the voice traffic against the list of voice fraud numbers originating fraudulent voice messages, and/or the originating phone number of the SMS traffic against the list of SMS spam message sources. If an anomaly is detected, the method proceeds to step 340. Otherwise, the method proceeds to step 399 (or to step 310 or step 320).

In step 340, method 300 provides a notification to the customer for the anomaly that is detected. For example, the application server notifies the customer in accordance with a rule for anomaly detection and notification associated with the particular customer.

In optional step 350, method 300 receives, from the customer, a request for accessing the notification. For example, the application server may store the notification in a database and provide a URL for the customer to access the notification. The customer may then click on the URL that is provided to access the notification.

In optional step 360, method 300 authenticates the customer. The method then proceeds to step 365.

In optional step 365, method 300 determines if the customer is successfully authenticated. If the customer is successfully authenticated, the method proceeds to step 370. Otherwise, the method proceeds to step 399 (or to step 310 or step 320).

In optional step 370, method 300 provides the customer access to the notification, e.g., permitting access to a database or a website. The notification may then be accessed by the customer.

In optional step 380, method 300 updates a database for a list of signatures of anomalies for mobile data traffic, a list of voice fraud numbers originating fraudulent voice messages, and/or a list of SMS spam message sources. The method then proceeds to step 310 to receive additional subscriptions for service, to step 320 to continue to collect traffic data, or to step 399 to end the process.

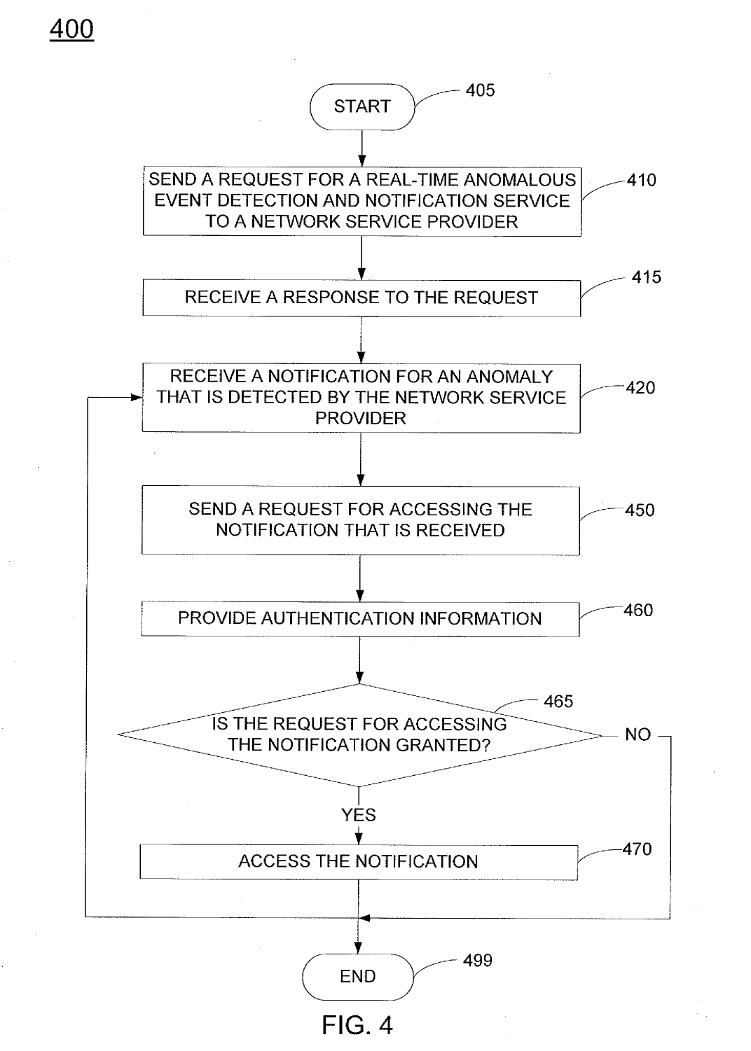

FIG. 4 illustrates a flowchart of a method 400 for obtaining a real-time anomalous event detection and notification service from a network service provider. In one embodiment, method 400 may be implemented in a user endpoint device, e.g., a mobile device, of a customer of a network service provider. Method 400 starts in step 405 and proceeds to step 410.

In step 410, method 400 sends a request for a real-time anomalous event detection and notification service to a network service provider. For example, a customer may subscribe to a real-time anomalous event detection and notification service via a mobile device. The request may comprise customer information, mobile device information, preferences for anomaly detection and notification, authentication information, etc.

In step 415, method 400 receives a response to the request for subscription. The response may comprise a confirmation of registration information, preferences, password, etc. Once the subscription is completed, the customer uses the mobile device for various services. For example, the customer may send/receive data traffic, send/receive voice calls, send/receive SMS messages, etc. In turn, the service provider collects the traffic data as the customer is accessing the various services. The service provider analyzes the traffic data that is collected and performs an analysis to detect anomalies in real-time (e.g., during the time frame as the traffic data for the customer is being transported over the network of the service provider. If an anomaly is detected, the service provider then sends a notification to the customer.

In step 420, method 400 receives a notification for an anomaly that is detected by the network service provider. For example, an application server of the service provider may send a notification to the customer in accordance with a rule for anomaly detection and notification associated with the customer. In one example, the notification may indicate that an anomaly is detected and provide a location, e.g., a website, where the notification can be accessed. In another example, the notification may comprise instructions for obtaining a remedy for the anomaly that is detected. In yet another example, the notification may comprise a script (e.g., software instructions) that can be run on the mobile device to accomplish the cleaning-up of the mobile device.

In optional step 450, method 400 sends, to the network service provider, a request for accessing the notification that is received. In one example, the network service provider may store the notification in a database and provide a URL for accessing the notification. The customer may then send a request for accessing the notification by clicking on the URL that is provided. In another example, the customer may be using a feature phone and may not be able to access a detailed notification on the mobile device. The customer may then access the notification via another device. The service provider may then request an authentication information, e.g., a password, fingerprint scan, retina scan, etc.

In optional step 460, method 400 provides authentication information. For example, the customer provides the authentication information, e.g., the password, fingerprint scan, retina scan, etc.

In optional step 465, method 400 determines if the request for accessing the notification is granted. In one example, the customer may be granted access to the notification. In another example, the authentication may be unsuccessful and access to the notification may be denied. If the request for accessing the notification is granted, the method proceeds to step 470. Otherwise, the method proceeds to step 420 to receive a notification for another anomaly or to step 499 to end the process.

In optional step 470, method 400 accesses the notification. For example, upon successful authentication, the customer may access the notification at a URL that is provided by the service provider. The method then proceeds to step 420 to receive a notification for another anomaly or to step 499 to end the process.

It should be noted that although not specifically specified, one or more steps or operations of each of the respective methods 300-400 may include a storing, displaying and/or outputting step as required for a particular application. In other words, any data, records, fields, and/or intermediate results discussed in each of the respective methods can be stored, displayed and/or outputted to another device as required for a particular application. Furthermore, steps, blocks, or operations in each of FIGS. 3-4 that recite a determining operation or involve a decision do not necessarily require that both branches of the determining operation be practiced. In other words, one of the branches of the determining operation can be deemed as an optional step.

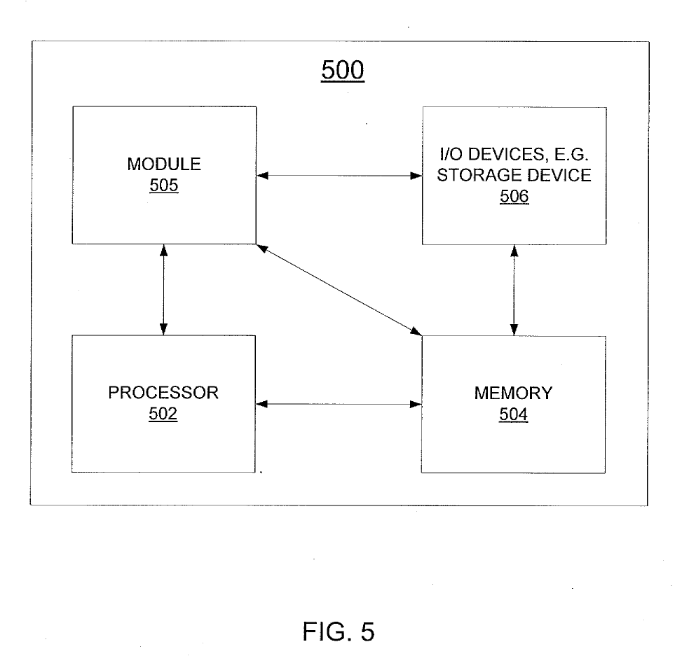

FIG. 5 depicts a high-level block diagram of a general-purpose computer suitable for use in performing the functions described herein. As depicted in FIG. 5, the system 500 comprises a hardware processor element 502 (e.g., a microprocessor, a central processing unit (CPU) and the like), a memory 504, e.g., random access memory (RAM) and/or read only memory (ROM), a module 505 for providing a real-time anomalous event detection and notification service in a wireless network, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the teachings of the present disclosure can be implemented in software and hardware, e.g., using application specific integrated circuits (ASIC), a general purpose computer or any other hardware equivalents, e.g., computer readable instructions pertaining to the method(s) discussed above can be used to configure a hardware processor to perform operations of the above disclosed methods. For example, a computer-readable medium may be in communication with the processor, where the computer-readable medium having stored thereon a plurality of instructions (e.g., a software program comprising computer-executable instructions), the plurality of instructions including instructions which, when executed by the hardware processor, cause the hardware processor to perform the operations (e.g., methods 300-400) as disclosed above.

in one embodiment, the present module or process 505 for providing a real-time anomalous event detection and notification service in a wireless network can be loaded into memory 504 and executed by processor 502 to implement the functions as discussed above. As such, the present method 505 for providing a real-time anomalous event detection and notification service in a wireless network (including associated data structures) of the present disclosure can be stored on a non-transitory (e.g., tangible or physical) computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a notification service in a wireless network, comprising:
registering, by a processor deployed in the wireless network, a mobile device associated with a customer for the notification service;
collecting, by the processor, traffic data related to the mobile device of the customer;
determining, by the processor, if an anomaly is detected for the traffic data that is collected for the mobile device; and
providing, by the processor, a notification to the mobile device of the customer, if the anomaly is detected for the traffic data that is collected for the mobile device.

2. The method of claim 1, wherein the determining if the anomaly is detected is performed in accordance with a rule for anomaly detection associated with the customer.

3. The method of claim 1, wherein the notification to the mobile device of the customer is provided in accordance with a rule for providing the notification associated with the customer.

4. The method of claim 1, wherein the notification to the mobile device of the customer is based on a type of the mobile device.

5. The method of claim 1, wherein the notification to the mobile device of the customer comprises a description of the anomaly that is detected.

6. The method of claim 1, wherein the notification to the mobile device of the customer comprises a suggestion for remediation.

7. The method of claim 1, wherein the notification to the mobile device of the customer comprises a level of urgency associated with the anomaly that is detected.

8. The method of claim 1, wherein the notification to the mobile device of the customer comprises a confidence level for the anomaly that is detected.

9. The method of claim 1, wherein the notification service is provided as an opt-in service.

10. The method of claim 1, wherein the notification service is provided as an opt-out service.

11. The method of claim 1, wherein the notification service is provided as a feature of another service.

12. The method of claim 1, further comprising:
updating a rule for the determining if the anomaly is detected.

13. The method of claim 12, wherein the updating is performed without affecting the mobile device.

14. The method of claim 1, wherein the anomaly that is detected is associated with the mobile device being infected with a malware.

15. The method of claim 1, wherein the anomaly that is detected is associated with the mobile device being a part of a botnet.

16. The method of claim 1, wherein the anomaly that is detected is associated with the mobile device being engaged in a fraud activity.

17. The method of claim 1, wherein the anomaly that is detected is associated with the mobile device receiving a spam message via a short message service.

18. The method of claim 1, wherein the anomaly that is detected is associated with the mobile device attempting to access a restricted content.

19. A tangible computer-readable medium to store a plurality of instructions, which, when executed by a processor deployed in a wireless network, cause the processor to perform operations for providing a notification service in the wireless network, the operations comprising:
registering a mobile device associated with a customer for the notification service;
collecting traffic data related to the mobile device of the customer;
determining if an anomaly is detected for the traffic data that is collected for the mobile device; and
providing a notification to the mobile device of the customer, if the anomaly is detected for the traffic data that is collected for the mobile device.

20. An apparatus for providing a notification service in a wireless network, comprising:
a processor deployed in the wireless network; and
a computer-readable medium in communication with the processor, to store a plurality of instructions which, when executed by the processor, cause the processor to perform operations, the operations comprising:
registering a mobile device associated with a customer for the notification service;
collecting traffic data related to the mobile device of the customer,
determining if an anomaly is detected for the traffic data that is collected for the mobile device; and
providing a notification to the mobile device of the customer, if the anomaly is detected for the traffic data that is collected for the mobile device.
